(19) United States
(12) Patent Application Publication
(10) Pub. No.: US 2025/0255322 A1
(43) Pub. Date: Aug. 14, 2025

(54) DRY COFFEE SUBSTITUTE MIXTURE

(71) Applicant: NORTHERN WONDER HOLDING B.V., Ede (NL)

(72) Inventor: Onno FRANSE, Ede (NL)

(73) Assignee: NORTHERN WONDER HOLDING B.V., Ede (NL)

(21) Appl. No.: 18/849,979

(22) PCT Filed: Mar. 21, 2023
(86) PCT No.: PCT/NL2023/050146

§ 371 Date: Sep. 23, 2024

(30) Foreign Application Priority Data
Mar. 22, 2022 (NL) 2031363

(51) Int. Cl. A23F 5/44; A23L 2/39; A23L 19/00; A23L 27/10; A23L 33/105

(52) U.S. Cl. CPC A23F 5/44; A23L 2/39; A23L 19/03; A23L 27/10; A23L 33/105

(57) ABSTRACT

The present invention is in the field of coffee substitutes, a method of preparations thereof, and use of such a coffee substitute, in particular a coffee substitute in the form of a mixture. Coffee substitutes are non-coffee products, that is of origin other than from a coffee bean or the like, which may be provided with or without caffeine, that are intended to imitate coffee. The coffee substitute can for instance be used to make a coffee-like drink.

### FIELD OF THE INVENTION

The present invention is in the field of coffee substitutes, a method of preparations thereof, and use of such a coffee substitute, in particular a coffee substitute in the form of a mixture. Coffee substitutes are non-coffee products, that is of origin other than from a coffee bean or the like, which may be provided with or without caffeine, that are intended to imitate coffee. The coffee substitute can for instance be used to make a coffee-like drink.

### BACKGROUND OF THE INVENTION

The present invention relates in general to a coffee substitute. Coffee substitutes are obtained from plant materials other than coffee. They may comprise caffeine or not, wherein caffeine can be added. Clearly coffee substitutes are intended to imitate coffee, mainly in view of taste and fragrance, but also in terms of appearance. Typically only one type of plant material is used as coffee substitute. For instance, roasted grain beverages are common substitutes for coffee. Other examples are acorns, chicory, and molasses. It is noted that obtaining a coffee substitute that closely mimics the characteristics of genuine coffee is still difficult. The substitutes themselves may also be considered as a base for a hot aromatic drink.

Coffee substitutes have been around since the 18^{th} century. These substitutes were mainly developed in periods when coffee supply was limited and affordability was low. The driver behind that development was thus the low availability and high price of coffee itself. Some of these substitutes have found their niche in the current marketplace, like chicory, barley, as well as blends. These products do not contain caffeine, do not really taste similar to coffee, and can not be brewed in all traditional or modern coffee methods and equipment.

The cultivation of coffee plants is however land occupation intensive. Also coffee plants can only be grown in limited climatological regions. Typically coffee crops compete with existing nature, such as tropical rain forest. The increase in coffee demand is prone to come at the cost of less rain forest. It is noted that coffee growth is in size the sixth cause of deforestation. Further, in view of climate change, coffee often has to be cultivated at higher altitudes, compared to previous decades, which comes at the costs of sacrificing even more land. Also cultivation of coffee involves rather large amounts of water. In particular tropical regions are therefore prone to losing valuable natural resources.

Incidentally reference can be made to “Coffee”, Vol. 5, Related beverages, R. J. Clarke et al, Elsevier, 1987, Chapter 1, GB 1 565 736 A, CA 1 184 418 A, and “Coffee”, Vol. 5, Related beverages, R. J. Clarke et al, Elsevier, 1988, p. 14 and 111. Both Clarke references recites that the term ‘coffee’ comprises not only the consumable beverage obtained by extracting roasted coffee with hot water, but also an entire range of intermediate products starting from the freshly harvested coffee cherries. Green coffee beans are, however, the main item of international trade (believed second in importance only to oil), for processing into roasted coffee, instant coffee and other coffee products, prepared for local consumers. The scientific and technical study of coffee in its entirety therefore involves a wide range of scientific disciplines and practical skills. It is evident that green coffee is a natural product of great compositional complexity, and this is even more true for coffee products deriving from the roasting of coffee. The present volume on the chemistry of coffee seeks to provide the reader with a full and detailed synopsis of present knowledge on the chemical aspects of green, roasted and instant coffee, in a way which has not been attempted before, that is, within the confines of a single volume solely devoted to the subject. Each chapter is directed towards a separate generic group of constituents known to be present, ranging individually over carbohydrate, nitrogenous and lipid components, not forgetting the important aroma components of roasted coffee, nor the water present and its significance, together with groups of other important components. Mixtures of roasted acorns, cereals and sugar beet, mixtures of roasted pulses and cereal, and mixtures of chicory, barley, barley malt rye and optionally figs appear to be present. Us of legumes appear to be mentioned in the second reference. GB 1 565 736 A, recites a product from which a beverage can be brewed said product comprising a mixture of 46—by weight, 11.5 to 12.5 by weight soya beans and 0.085 to 1.15% by weight of coffee flavouring. CA 1 184 418 A recites a natural coffee substitute and process for preparing same are provided herein. It comprises dry roasted artichoke comprising 75% to 25% Jerusalem artichoke and correspondingly 25% to 75% Chinese artichoke. The artichoke coffee is not cancer forming or causing, has good colouring, and blends with many other foods. It can be added to foods which may be baked or cooked in any style. The artichoke coffee will keep well if stored properly. It has no oils that would make it costly to produce. Nothing need be added for any reason. It is not habit forming and is not in any way injurious to health.

The present invention therefore relates to an alternative coffee substitute, which solves one or more of the above problems and draw backs of the prior art, providing more reliable results, without jeopardizing functionality and advantages.

### SUMMARY OF THE INVENTION

It is an object of the invention to overcome one or more limitations of the prior art and provide a coffee substitute of non-tropical plant ingredients. The present invention provides coffee substitutes made from non-tropical ingredients, of which the taste is quite similar to coffee, which can be brewed similar to coffee, and are provided with and without caffeine. The coffee substitutes may be provided as such, in the form of a container comprising said coffee substitute, such as a capsule, etc. The present invention is based on very thorough analytical and sensory R&D on coffee and its potential alternative ingredients in all stages of the process, enabling to re-create ground coffee substitute via innovative blends of non-tropical ingredients. In particular use is made of a combinations of at least two of such plant ingredients, in particular wherein the at least two plant ingredients belong to different plant families. By making use of non-tropical ingredients not only the pressure on tropical forest may be reduced, but also overall water-consumption, transport energy, and transport costs may be reduced. Tropical vegetation is any vegetation in tropical latitudes, whereas the non-tropical vegetation is found elsewhere, in so far as applicable. Although tropical vegetation might occur outside tropical latitudes, and vice versa, in particular due to climate change and human intervention, the terms are normally interpreted as above. The present invention relates to a blend of plant ingredients, which when blended carefully, and prepared accordingly, are considered to provide a good coffee substitute, in particular in terms of flavours, in particular aromas, taste, and fragrances. In particular the present homogenized mixture of roasted particles provides good coffee flavours, in particular aromas, taste, and fragrances, upon extraction thereof, comparable with natural coffee extracts. It is noted that taste, scent, mouth feel, and so on, on the one hand, and molecules being present and being released, on the other hand, are closely related. In order to obtain a suitable dry coffee substitute the present inventors have developed a mixture comprising roasted particles of a homogenized mixture, the mixture comprising >90 wt. % of at least two non-tropical plant ingredients, in particular >95 wt. %, wherein the non-tropical ingredients are selected from the plant family of Fabaceae, in particular from the sub-family Papilionoideae, and from the sub-family Caesalpinioideae, from the plant family of Poaceae, in particular from the sub-family Pooideae, from the plant family of Moraceae, from the plant family of Vitaceae, in particular from the sub-family Vitoideae, from the plant family of Asteraceae, in particular from the sub-family Cichorioideae, and combinations thereof, 0-8 wt. % natural non-tropical flavours, and 0-10 wt. % water, in particular 4-8 wt. % water, more in particular 5-6 wt. % water, wherein the water is typically present incorporated in, within, or on the present mixture, wherein all weight percentages are based on a total weight of the mixture, wherein the particles have an average particle size of 0.1-2 mm with a standard deviation<0.2*average particle size, in particular an average particle size of 0.3-1.0 mm, preferably with a standard deviation<0.15*average particle size, more in particular an average particle size of 0.4-0.7 mm, in particular where in the particle size is determined using laser scattering. Natural flavour are known as edible aroma compounds that are found in nature, such as in plants, animals, enzymes, and microorganisms, or produced thereby, and are therefore not produced by human beings. In nature they therefore always are present with other natural substances that also may be flavour. Natural flavours can be isolated on industrial scale, to be used as an additive. The present inventors in particular make use of natural flavours obtained from organisms in nature, in particular from non-tropical plants if possible, and/or from microorganisms. Some important aspects in view mimicking coffee are the present mixture comprising at least two non-tropical ingredients, therewith reducing an impact on the environment, the roasting thereof, the mixing thereof, and the control of the particle size distribution within the specific size limits.

In a second aspect the present invention relates to a method of forming a dry coffee substitute mixture according to the invention, comprising providing a homogenized mixture according to the invention, in particular providing a dried mixture, that is dried to less than 5 wt. % water, optionally drying said mixture at a temperature of 70-100° C., and/or during a dry time of 1-60 minutes, and/or at a reduced pressure of 1-10 kPa, if required in order to reach the amount of water as required, roasting the mixture at a roast temperature of 70-350° C., and/or during a roast time of 1-60 minutes, or obtaining a roasted mixture, such as roasting in a drum roaster or in a hot air roaster, grounding said mixture, in particular to a mixture with an average particle size of the mixture of at least two non-tropical ingredients is 0.1-2 mm with a standard deviation<0.2*average particle size, sieving said mixture over a sieve, in particular over a sieve with a mesh size of 0.1 mm, blending said mixture into a blend, optionally adding the natural flavours, and optionally adding caffeine to the blend.

Advantages of the present description are detailed throughout the description.

### DETAILED DESCRIPTION OF THE INVENTION

In an exemplary embodiment of the present dry coffee substitute mixture the non-tropical ingredients are selected from the plant tribe Genisteae, such as Lupinus polyphyllus, from the plant genus Hordeum, such as Hordeum vulgare, from the plant genus Secale, such as Secale cereale, from the plant genus Cicer, such as Cicer arietinum, from the plant genus Ficus, in particular from the Subgenus F. subg. Ficus, such as Ficus carica, from the plant genus Ceratonia, such as Ceratonia siliqua, from the plant genus Vitis, from the plant tribe Cichorieae, in particular from the plant genus Cichorium, such as Cichorium intybus, and combinations thereof.

In an exemplary embodiment of the present dry coffee substitute mixture the non-tropical ingredients are further selected from the plant family of Ericaceae, in particular from the plant genus Vaccinium, more in particular from the plant section Cyanococcus such as blueberry, and from the plant sub-genus Vaccinium oxycoccus such as cranberry, from the plant family of Grossulariaceae, in particular from the plant genus Ribes, more in particular from the Ribes nigrum such as blackcurrant, from the plant family of Rosaceae, in particular from the plant genus Rubus, more in particular from the plant sub-genus Rubus such as blackberry. Each of these further ingredients individually may be present in an amount of in particular 0-5 wt. %, more in particular 0.1-3.5 wt. %, even more in particular 0.5-3 wt. %, such as 2-3 wt. %.

In an exemplary embodiment of the present dry coffee substitute mixture the non-tropical ingredients are selected from non-tropical ingredients as such, from non-tropical ingredients in malted form, from non-tropical ingredients in fermented form, and combinations thereof.

In an exemplary embodiment of the present dry coffee substitute mixture the non-tropical ingredients are selected from non-tropical ingredients as such, from parts of the non-tropical ingredients, such as a skin thereof, in particular grape skin, and combinations thereof.

In an exemplary embodiment of the present dry coffee substitute mixture the particles of dry coffee substitute mixture or parts thereof are fermented particles, in particular fermented using at least one of bacteria, yeasts, and enzymes, more in particular using a single-celled microorganism from the Family of Saccharomycesaceae, in particular of the Genus Saccharomyces, such as the Species S. cerevisiae, or of the genus Lactobacillus, such as Lactobacillus acidophilus, Lactobacillus casei, Lactobacillus delbrueckii, in particular Lactobacillus bulgaricus, Lactobacillus helveticus, Lactococcus lactis, or of the genus Streptococcus, in particular Streptococcus salivarius, such as Streptococcus thermophilus, or of the genus Acetobacter, during a fermentation time of 1-48 hours, in particular 2-24 hours, more in particular 6-12 hours, and during a fermentation temperature of 10-40° C., in particular 15-39° C., more in particular 25-38° C.

In an exemplary embodiment of the present dry coffee substitute mixture the dry coffee substitute mixture comprises roasted particles, in particular roasted at a roast temperature of 70-350° C., more in particular 150-300° C., and/or during a roast time of 1-60 minutes, more in particular 5-30 minutes, in particular for Lupin a roast time of 5-15 minutes and a temperature of 200-240° C., for chickpea a roast time of 10-25 minutes and a temperature of 180-220° C.

In an exemplary embodiment of the present dry coffee substitute mixture further comprising 0.01-2 wt. % caffeine (CAS 58-08-2), in particular 0.1-1.1 wt. %, such as 0.9-1.0 wt. %.

In an exemplary embodiment of the present dry coffee substitute mixture the particle size of the mixture is larger than sieve openings being 0.1 mm and smaller than sieve opening being 1 mm. In an alternative a roller grinding technology could be used, typically leading to a more narrow particle size distribution.

In an exemplary embodiment of the present dry coffee substitute mixture comprising at least three non-tropical ingredients, in particular at least four non-tropical ingredients, wherein the non-tropical ingredients are selected from the genus Hordeum, such as Hordeum vulgare, such as barley, from the genus Secale, such as Secale cereale, such as rye, from the plant tribe Genisteae, in particular form the genus Lupinus, such as Lupinus polyphyllus, such as lupin, from the plant tribe Cichorieae, in particular from the plant genus Cichorium, such as Cichorium intybus, such as chicory, with the proviso that the non-tropical ingredients are selected from different genus, in particular comprising 1-40 wt. % of the genus Hordeum, in particular 5-38 wt. %, more in particular 15-35 wt. %, even more in particular 18-33 wt. %, such as 20-32 wt. %, 1-40 wt. % of the genus Secale, in particular 5-38 wt. %, more in particular 15-35 wt. %, even more in particular 18-33 wt. %, such as 20-32 wt. %, 1-40 wt. % of the plant tribe Genisteae, in particular 5-38 wt. %, more in particular 15-35 wt. %, even more in particular 18-33 wt. %, such as 20-32 wt. % wherein for capsules the percentages are relatively lower, such as 20-24 wt. % for the above ingredients each individually, wherein for filters the percentages are relatively higher, such as 23-27 wt. % for the above ingredients each individually, and 1-15 wt. % of the plant tribe Cichorieae, in particular 2-13 wt. %, more in particular 5-12 wt. %, even more in particular 7-10 wt. %, such as 8-9 wt. % for a filter and 7-8 wt. % for a capsule mixture.

In an exemplary embodiment of the present dry coffee substitute mixture comprising 0.1-4 wt. % non-tropical flavours, in particular 0.2-2 wt. %, such as 0.3-1.3 wt. %, in particular wherein the flavours are selected from molecules comprising at least one of a furan, a ketone, a phenol, a pyrrole, a pyrazine, an aldehyde, an acid, a pyranone, and an alcohol, in particular with the proviso that the natural flavour is not obtained from a coffee bean, that is, from another natural origin, such as a plant, in particular a non-tropical plant, or from a microorganism.

In an exemplary embodiment the present method further comprises thoroughly mixing the ingredients of the mixture.

In an exemplary embodiment the present method further comprises forming the mixture into a coffee substitute, in particular wherein the coffee substitute is selected from a coffee-like drink.

The invention will hereafter be further elucidated through the following examples which are exemplary and explanatory of nature and are not intended to be considered limiting of the invention. To the person skilled in the art, it may be clear that many variants, being obvious or not, may be conceivable falling within the scope of protection, defined by the present claims.

### EXAMPLES

### General

Roast the raw single ingredients until a dark brown colour has been formed, generally roasting temperatures are between 180-250° C. and roasting times between 5-25 minutes depending on the single ingredient;
Grind the single ingredients into a course ground with particles between 0.1 and 1.5 mm;
If necessary, sieve the single ingredients separately removing particles below 0.2 mm and above 1 mm;
Mix the single ingredients in the given ratios until a homogeneous blend is obtained;
Mix the fine powders together with water using fluidized bed technology and dry to create an agglomerated particle mixture;
If applicable, add the agglomerated particle mixture to the single ingredient blend;
Process the blend according to their brewing application.

### Filter

Blend composition: 25% lupin, 25% malted rye, 25% malted barley, 9.2% chickpea, 8.3% chicory, 7.5% agglomerated particle mixture adding 3.5% carob powder, 2% blackcurrant, 1% caffeine and 1% flavour to the final blend.
After roasting and grinding of the single ingredients, the individual ingredients are sieved to obtain particles between 0.4-1 mm;
After the formation of a homogeneous blend, the product is packed into pouches and stored at room temperature until consumption.

### Capsules

Blend composition: 21.5% lupin, 21.5% malted rye, 21.5% malted barley, 10.6% figs, 9.7% chickpea, 7.7% chicory, 7.5% agglomerated particle mixture adding 3.5% carob powder, 2% blackcurrant, 1% caffeine and 1% flavour to the final blend.
After roasting and grinding of the single ingredients, the individual ingredients are sieved to obtain particles between 0.2-1 mm;
After the formation of a homogeneous blend, 5.5-7.5 grams of the product is filled into capsules which are then sealed;
The filled capsules are packed into boxes and stored at room temperature until consumption.

1. A dry coffee substitute mixture, comprising
roasted particles of a homogenized mixture, the mixture comprising >90 wt. % of at least two non-tropical plant ingredients, wherein the at least two plant ingredients belong to at least two different plant families, wherein the non-tropical ingredients are selected from the plant family of Fabaceae, from the plant family of Poaceae, from the plant family of Moraceae, from the plant family of Vitaceae, from the plant family of Asteraceae, and combinations thereof,
0-8 wt. % natural non-tropical flavours, and
0-10 wt. % water,
wherein all weight percentages are based on a total weight of the substitute mixture,
wherein the particles have an average particle size of 0.1-2 mm wherein the particle size is determined using laser scattering.

2. The dry coffee substitute mixture according to claim 1, wherein the non-tropical ingredients are selected from the plant tribe Genisteae, from the plant genus Hordeum, from the plant genus Secale, such as Secale cereale, from the plant genus Cicer, from the plant genus Ficus, from the plant genus Ceratonia, from the plant genus Vitis, from the plant tribe Cichorieae, and combinations thereof,
and selected from the plant family of Ericaceae, and from the plant sub-genus Vaccinium oxycoccus, from the plant family of Grossulariaceae, from the plant family of Rosaceae.

3. The dry coffee substitute mixture according to claim 1, wherein the non-tropical ingredients are selected from non-tropical ingredients as such, from non-tropical ingredients in malted form, from non-tropical ingredients in fermented form, and combinations thereof.

4. The dry coffee substitute mixture according to claim 1, wherein the non-tropical ingredients are selected from non-tropical ingredients as such, from parts of the non-tropical ingredients, and combinations thereof.

5. The dry coffee substitute mixture according to claim 1, wherein the particles of dry coffee substitute mixture or parts thereof are fermented particles using at least one of bacteria, yeasts, and enzymes, during a fermentation time of 1-48 hours and during a fermentation temperature of 10-40° C.

6. The dry coffee substitute mixture according to claim 1, wherein the dry coffee substitute mixture comprises roasted particles, roasted at a roast temperature of 70-350° C., and during a roast time of 1-60 minutes.

7. The dry coffee substitute mixture according to claim 1, further comprising 0.01-2 wt. % caffeine (CAS 58-08-2).

8. The dry coffee substitute mixture according to claim 1, wherein the particle size of the mixture is larger than sieve openings being 0.1 mm and smaller than sieve opening being 1 mm.

9. The dry coffee substitute mixture according to claim 1, comprising at least three non-tropical ingredients, wherein the non-tropical ingredients are selected from the genus Hordeum, from the genus Secale, from the plant tribe Genisteae, from the plant tribe Cichorieae, with the proviso that the non-tropical ingredients are selected from different genus,
in particular comprising
1-40 wt. % of the genus Hordeum,
1-40 wt. % of the genus Secale,
1-40 wt. % of the plant tribe Genisteae,
and
1-15 wt. % of the plant tribe Cichorieae.

10. The dry coffee substitute mixture according to claim 1,
comprising 0.1-4 wt. % non-tropical flavours, wherein the flavours are selected from molecules comprising at least one of a furan, a ketone, a phenol, a pyrrole, a pyrazine, an aldehyde, an acid, a pyranone, and an alcohol, with the proviso that the natural flavour is not obtained from a coffee bean.

11. A method of forming a dry coffee substitute mixture according to claim 1, comprising
providing a homogenized mixture according to claim 1,
roasting the mixture at a roast temperature of 70-350° C., and during a roast time of 1-60 minutes,
grounding said mixture to a mixture with an average particle size of the mixture of at least two non-tropical ingredients is 0.2-2 mm with a standard deviation<0.2*average particle size,
sieving said mixture over a sieve over a sieve with a mesh size of 0.1 mm, and
blending said mixture into a blend.

12. The method of forming a dry coffee substitute mixture according to claim 11, further comprising
thoroughly mixing the ingredients of the mixture.

13. The method of forming a dry coffee substitute mixture according to claim 11, further comprising
forming the mixture into a coffee substitute, wherein the coffee substitute is selected from a coffee-like drink.

14. The dry coffee substitute mixture according to claim 1, wherein the non-tropical ingredients are selected from the sub-family Papilionoideae, from the sub-family Caesalpinioideae, from the sub-family Pooideae, from the sub-family Vitoideae, from the sub-family Cichorioideae, and combinations thereof.

15. The dry coffee substitute mixture according to claim 1, wherein the particles of dry coffee substitute mixture or parts thereof are fermented particles using a single-celled microorganism selected from the Family of Saccharomycesaceae, from the genus Lactobacillus, from the genus Streptococcus, and from the genus Acetobacter.

16. The dry coffee substitute mixture according to claim 1, wherein the dry coffee substitute mixture comprises roasted particles, for Lupin at a roast time of 5-15 minutes and a temperature of 200-240° C., and for chickpea a roast time of 10-25 minutes and a temperature of 180-220° C.

17. The dry coffee substitute mixture according to claim 1, comprising
5-38 wt. %, of the genus Hordeum,
5-38 wt. %, of the genus Secale,
5-38 wt. %, of the plant tribe Genisteae,
and
2-13 wt. % of the plant tribe Cichorieae.

18. The dry coffee substitute mixture according to claim 1, comprising 8-9 wt. % of the plant tribe Cichorieae for a filter and 7-8 wt. % of the plant tribe Cichorieae for a capsule mixture.

19. The method according to claim 11, comprising
drying said mixture at a temperature of 70-100° C., and during a dry time of 1-60 minutes, and at a reduced pressure of 1-10 kPa,
adding the natural flavours, and
adding caffeine to the blend.
